(19) United States
(12) Patent Application Publication
(10) Pub. No.: US 2008/0101713 A1
(43) Pub. Date: May 1, 2008

(54) System and method of fisheye image planar projection

(76) Inventor: Albert D. Edgar, Austin, TX (US)

Correspondence Address: Image Trends, Inc.;Suite 450, Building One, 6300 Bridgepoint Parkway, Austin, TX, 78730, US

(21) Appl. No.: 11/975,855

(22) Filed: Oct. 22, 2007

Related U.S. Application Data
(60) Provisional application No. 60/854,833, filed on Oct. 27, 2006.

(51) Int. Cl. G06K 9/40

(52) U.S. Cl. 382/260

(57) ABSTRACT

Various embodiments of a system and method of fisheye lens image planar projection are disclosed. In general, an image created by a camera with a fisheye lens is mapped to an output image in such a way as to greatly reduce perceived distortions of people and other subjects in the output image. An advantage of at least one embodiment is that ultra wide angle fisheye lenses can now be used in a wide range of photographic situations.

### CROSS REFERENCE TO RELATED APPLICATIONS

This application claims priority under 35 U.S.C. 119(e) to U.S. Provisional Patent Application No. 60/854,833, entitled System and Method of Fisheye Lens Image Planar Projection, having a priority filing date of Oct. 27, 2006, and attorney docket no. ITI-06001.

### FIELD OF THE INVENTION

This invention generally relates photography and more specifically to a system and method of fisheye lens image planar projection.

### BACKGROUND OF THE INVENTION

The photography market continues to expand as new digital cameras, computers and printers make it easier for people to take, store, share and print their pictures. Consumer interest in capturing large area images is growing with the photography market.

Most lenses use “rectilinear” projection, which means “straight line”. A pinhole camera is a “perfect” rectilinear projection. With such a projection, a line at any arbitrary orientation in the world maps to a straight line on the print. In such a projection, the radial distance an object appears from the center of the print is proportional to the tangent of the angle from the normal of the front lens element that the object exists in front of the lens. With small angles from the normal, this tangential function is nearly proportional to angle, and so non-distorting in all aspects. However at larger angles the tangential function grows rapidly, hitting a singular infinity point at plus/minus 90 degrees=180 degree total angle. For this reason a rectilinear projection can not handle total angles approaching 180 degrees.

One method for capturing large area images is to use a lens that views a larger area than can be linearly projected onto the film. Modern advances in optics have given photographers better non-rectilinear lenses, such as the modern hemispherical, or fisheye, lens. The problem is that non-rectilinear lenses distort the image.

For a fisheye lens, the real world can be considered to be projected outward onto a global sphere centered on the camera. There is no “right” way to map a sphere to a plane, however there are many attempts to improve the perceptual accuracy of various aspects of the image. Mathematicians typically define lens distortion exclusively in terms of how straight lines are bent, but this method does not address several other aspects of distortion.

A few lenses are built to other projections. By far the most common non-rectilinear, including virtually all current commercial non-rectilinear lenses, is the equal-solid-angle fisheye lens. This projection is defined such that the solid angle occupied by an object in front of the lens maps to an image with the same area no matter where the object is in the field of view. The fisheye projection compresses progressively with larger angles. The result is that the fisheye lens distorts people standing at the edges by compressing them horizontally and making them unnaturally tall. A fisheye projection also bends any straight line that does not pass through the optical center. Thus not only does a normal person appear very tall and skinny on the edge of a fisheye image, but the person is also bent into a half-moon.

Fisheye lenses have generally been relegated to special effects because of the perceptual distortions. With the advent of digital image processing, remapping of fisheye images is now practical for many photographers. Existing technologies undistort a fisheye image in a technical sense by mapping the image to a rectilinear projection. The standard definition of “distortion” is how much lines are bent, and rectilinear is the only technically “distortionless” projection.

No matter how mathematically perfect at making lines straight, forcing a rectilinear projection at the extreme angles encompassed by a fisheye uncovers a number of problems. These problems include often grotesque distortion of people in non-socially acceptable ways, such as making them appear humorously obese. Further, the extreme expansion of a rectilinear projection magnifies the edge of the image to reveal lens resolution problems, and compresses the center of the image to loose detail the lens has been able to capture, thereby overall making images look un-sharp and grainy. Further the rectilinear projection is unable to map large areas at the edges of the fisheye image within the rectangular bounds of the originally captured image, thereby cropping out edge detail and making it very difficult for a photographer to frame and compose in the viewfinder when taking the picture.

### SUMMARY OF THE INVENTION

The present invention has several important technical advantages. Various embodiments of the present invention may have none, some, or all of these advantages.

In one embodiment of the present invention, a non-rectilinear lens correction program is provided. In one embodiment, a photographic image created with a non-rectilinear lens is processed by the program to reduce the vertical line distortion, spherical distortion and frame distortion to create an output image. The spherical distortion is preferably reduced by approximately 75-95 percent. The vertical line distortion is preferably reduced by over 95 percent. The frame distortion of the horizontal edges of the image is preferably reduced.

The non-rectilinear lens correction program is preferably optimized for a fisheye lens. The program may also include manual controls that allow a user to vary the level of distortion of the output image, such as brushes and slider bars.

In another implementation of the present invention, a method for non-rectilinear lens image planar projection is provided. In one embodiment, the implementation includes the following steps: receiving an original image created using a non-rectilinear lens; mapping the original image to a flat surface; processing the mapped image to reduce vertical line, spherical and frame distortion; and outputting the processed image. In the preferred embodiment, the vertical line, spherical and frame distortions are minimized to perceptually pleasing levels.

An advantage of at least one embodiment of the present invention is that pictures taken with a non-rectilinear lens and processed by the non-rectilinear lens correction program are perceptually more enjoyable to consumers than conventional solutions. Other technical advantages will be readily apparent to one skilled in the art from the following figures, descriptions, and claims.

### BRIEF DESCRIPTION OF THE DRAWINGS

For a more complete understanding of the invention and the advantages thereof, reference is now made to the following description taken in conjunction with the accompanying drawings in which:

FIG. 1 is a schematic illustration of a digital image processing system in accordance with one embodiment of the invention;

FIG. 2 is a schematic illustration of the operation of a certain common lens projections;

FIG. 3 is a schematic illustration of various optical and projection distortions, including vertical line, sphere, and framing distortions;

FIG. 4 is a schematic illustration of a slight positive sphere distortion;

FIG. 5 illustrates the method of operation of the pseudo code of a computer program;

FIG. 6 illustrates the function of a “twist” parameter in the pseudo code of FIG. 5; and

FIG. 7 compares one embodiment of the present invention with the prior art.

### DETAILED DESCRIPTION OF THE PREFERRED EMBODIMENTS

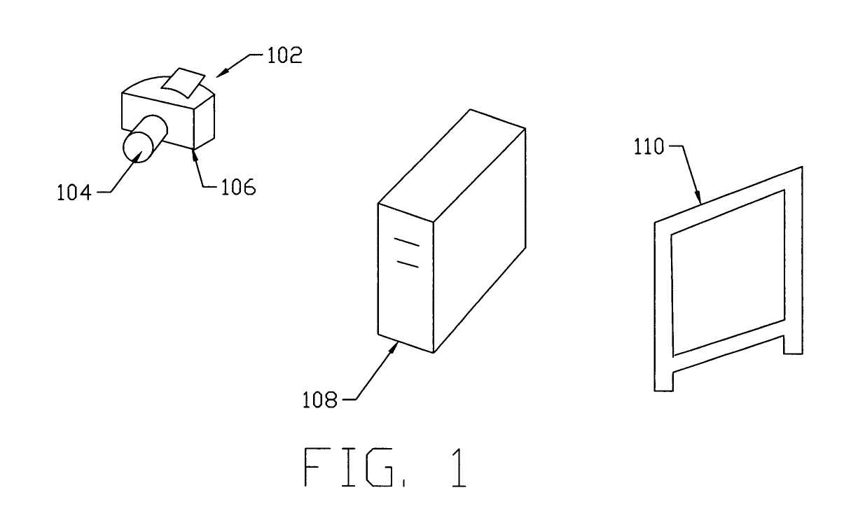

FIGS. 1 through 7 illustrate various embodiments of the present invention. The present invention is illustrated in terms of a fisheye lens. It should be understood that the present invention may be used in any suitable non-rectilinear lens or such other imaging solution without departing from the spirit and scope of this invention.

FIG. 1 is a schematic diagram of one embodiment of a digital image processing system 100. In this embodiment, a camera 102 holds a fisheye lens 104 in front of a sensor 106 within the camera 102. The sensor 106 may comprise a digital sensor or a chemical sensor such as film. An original image 107 is recorded by the sensor 106 and input to a computer 108. The original image 107 is input into computer 108 and a fisheye correction program 109 operates on the image 107 to produce an output image 111 that perceptually minimizes distortion of human and other subjects. The specific distortions that are substantially reduced or rectified include: the correction of vertical line distortion so that straight vertical lines in the original subject are straight in the output image 111; the correction of sphere distortion so that details such as faces or other small dimensional objects in the original image 107 appear in the output image 111 to have the correct aspect ratio; and the correction of framing distortion so that the top and bottom edges of the original image 107 accurately bound the composition of the output image 111.

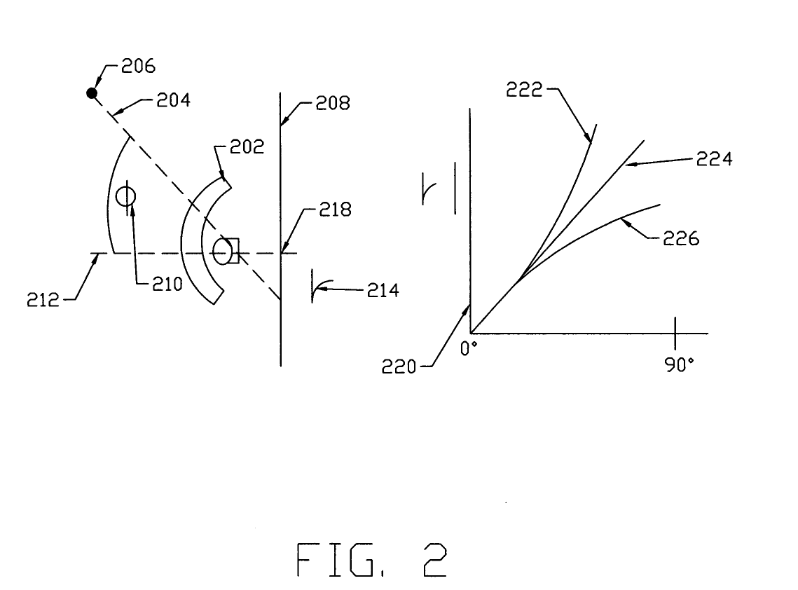

FIG. 2 illustrates the operation of a fisheye lens 202. The fisheye lens 202 focuses a light ray 204 from an image point 206 onto a photosensitive planar surface 208, which may be a film, a CMOS sensor, a CCD sensor, or other technology known in the art. The light ray 204 forms and angle 210 relative to the lens axis 212, also called the line normal to the front element of the lens. The optical elements focus this light ray onto the planar sensor 208 at a point that is a radius 214 distant from the center of the sensor 218 at the intersection with the lens axis 212.

The relationship between the angle 210 and the radius 214 is further explored in graph 220 of FIG. 2. If the radius is proportional to the tangent of the angle, such as in curve 222, the projection is commonly called a rectilinear projection. This projection maintains the straightness of any arbitrary line in front of the lens onto a straight line on the sensor. However the tangential curve 222 reaches infinity at an angle of 90 degrees. It may be appreciated that a pinhole lens obeys the tangential relationship.

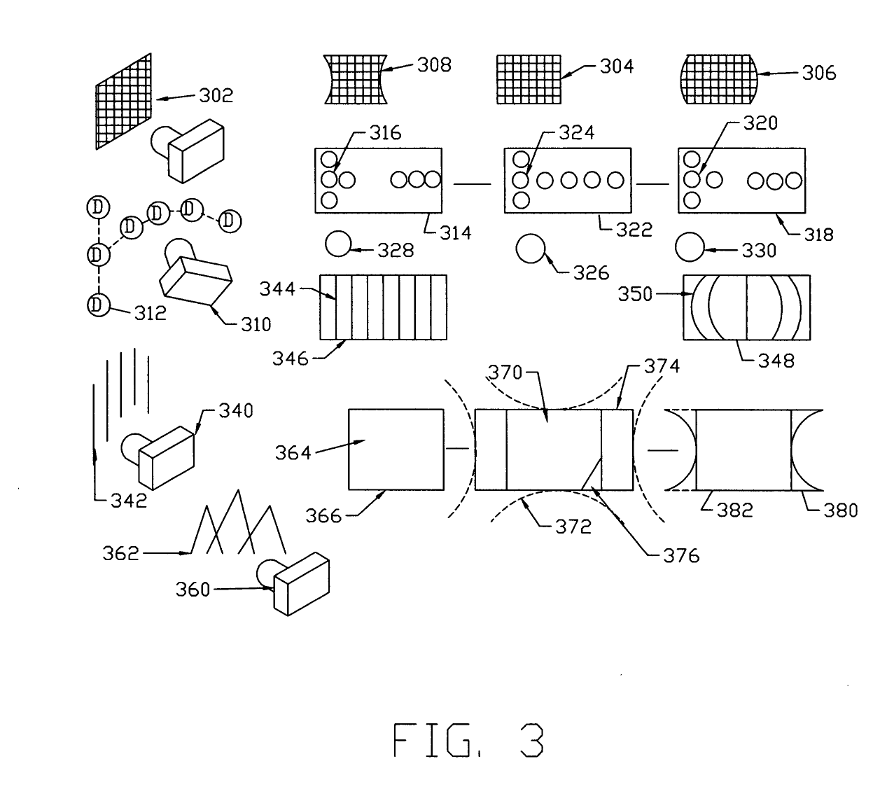

Another linear function is shown in curve 224 in which the angle and radius are proportional. An equal-solid-angle fisheye follows a sublinear curve 226. Although this is a common design point of commercial fisheye lenses, in popular use a “fisheye” is used to mean a very wide angle lens with very strong pincushion distortion, which certainly includes the equal-solid-angle projection. If a square object 302 as shown in FIG. 3 is photographed with a perfect rectilinear lens, it will be seen with straight edges 304. If the edges appear bowed out 306, it is said in common use to have “pincushion distortion”, and if bowed in 308 it is said to have “barrel distortion”.

Fisheye lenses are further distinguished by their focal length and angle of coverage. The most common commercially available fisheye lenses cover 180 degrees, and project the edge of the covered field into the extreme diagonal corners of the captured frame. Because this just covers the entire field of the image, these are called “full field” fisheye lenses.

In common use, a perfect rectilinear lens is said to have zero distortion because lines are perfectly straight, and therefore a photographed flat grid parallel to the front element of the lens appears perfectly reproduced. As wider angle lenses become popular, it is apparent that this definition of distortion is inadequate. The problem is equivalent of the mapmakers problem of how to represent a globe onto a flat sheet of paper. For maps of small areas, such as cities or states, the problem is minor, as with telephoto lenses, however as nations or continents or hemispheres are included, the problem becomes severe, as it is with ultrawide and fisheye lens angles. There is no “right” answer. It is possible to achieve zero distortion according to almost any single definition, but there are many ways to define distortion, and the globe to flat map transformation does not allow zero distortion in all aspects.

In one embodiment of the present invention, the computer program 109 is optimized to low distortion using nonstandard definitions of distortion. These definitions are human centric, based on the representation of the human body and the perception of the distortion by the human visual system.

In this embodiment, one of the important aspects in the photography of human subjects is to minimize distortion of faces. This distortion is mathematically expressed in this application as “sphere distortion”, which is now defined. Referring again to FIG. 3 a camera 310 is surrounded by small spheres, such as ball bearings. An equivalent test can be constructed of circular disks if the disks are precisely aligned normal to the lens. Such a disk could what is generally called a CD, and the alignment can be confirmed if the lens sees its own reflection in the center of the disk. The use of a sphere in this test obviates this alignment step. A particular sphere 312 is represented in the digitized image captured by the camera as a shape 314.

In a rectilinear projection image 314, the sphere is represented by an ellipsoid 316 elongated sagittally. This elongation will be called “sphere distortion” and will be quantified as the degree of elongation sagittally. In a rectilinear lens, sphere distortion grows rapidly with angle, so for a “normal” lens it is barely noticed, but for an extreme wide angle rectilinear this sphere distortion is extreme. An equal-solid-angle fisheye image 318 has negative sphere distortion as the ellipsoid is compressed in the sagittal axis, which is the same as expansion tangentially. Using this definition of distortion, an undistorting image 322 would represent all spheres in front of the camera as circles 324 in the final image.

The discovery of the importance of sphere distortion in photography of human subjects is now explained. Imagine the spheres were instead faces in a crowd surrounding the camera. In a projection without sphere distortion, each of the faces would be represented with the natural aspect ratio 326. In a positive distorting projection, such as a rectilinear, the face 328 at a left or right edge of the image would appear unnaturally broad, and conversely a face at the top or bottom edge would be narrowed. Bodies that underwent the same distortion would also appear unnaturally broad at the sides. Conversely faces or bodies that underwent a negative sphere distortion would appear unnaturally narrow 330 at the left or right of the image. This sphere distortion is the most damaging to images that contain not only people, but most organic objects where aspect is the most important aesthetic.

Through widespread viewing in modern society of images in magazines, movies, etc., and because almost all images are made through a rectilinear lens, it has been discovered that the human visual system has adapted to a small degree and expects to see positive sphere distortion in what is perceived as a wide angle image. If presented with a wide angle image with no sphere distortion, it has been discovered that the human visual system, conditioned with years of viewing rectilinear images, actually perceives a slight negative distortion. Such conditioned responses of the human visual system are quite common in society, for example a clock running backwards appears for a moment to be frozen still, although such an adaptation is becoming rarer among children seeing only digital clocks. This discovery has led to the desirability of introducing a slight positive sphere distortion into a wide angle image even if sphere distortion can be reduced to zero. The optimum magnitude of this correcting distortion is small. The optimum magnitude is dependent on the perceived angle and other factors and is best found empirically, but a typical amount is 15% of the amount that would be produced by an equivalent rectilinear lens. Obviously this is only an approximation at wide angles, for example a rectilinear lens would give infinite distortion at the edges of a 180 degree field. In such an image the adapted eye requires about 20% distortion to perceive no distortion.

The term “minimize” and such other level descriptive terms used in this patent do not mean absolute mathematical minimums, but means perceptive minimums. For example, as indicated above, the spherical distortion could be reduced to a mathematical minimum, but will not produce a visually appealing image. In this example, minimizing the spherical distortion means reducing the spherical distortion to an optimal minimum level, which as indicated above is approximately 10 to 25 percent of the amount that would be produced by an equivalent rectilinear lens.

It has been further discovered that requiring a specific sphere distortion does not uniquely define a projection, there are still variables left undefined. This is different from a rectilinear requirement which exactly defines a unique solution. Because zero sphere distortion is not a unique definition, it is possible to concurrently minimize other distortions that one chooses. For the purposes of this patent, those distortions will be selected to minimize distortion of people and related subjects.

Referring again to FIG. 3, a further distortion, here called the “vertical line distortion”, is now defined. Given a camera 340 aimed to center at the horizon and surrounded by vertical straight lines, such as line 342, the image made with the camera will reproduce the line 344 on a print such as 346. In this illustration print 346 may be made with camera 340 fitted with a rectilinear lens because line 344 is seen to be straight, however because there is no constraint on lines at other angles, it does not need to be a rectilinear projection in which all lines are forced to be straight. Conversely in image 348, which could have resulted by fitting camera 340 with a fisheye lens, line 350 is seen to be curved. Vertical line distortion is said to be zero when the vertical lines are reproduced as straight lines on the print.

It has been discovered that maintaining the straightness of vertical lines is much more important in human images, and indeed most life images, than maintaining the straightness of other lines, such as horizontal. People normally stand vertically, and far more images are made with the body standing or sitting with the torso and head vertical than are made with the body lying prone. Further, when bent into a half moon in a standing position the effect is more disturbing. Furthermore, trees, lampposts, plants, buildings, etc tend to align vertically with gravity, and their linear distortion is more apparent and disturbing when curved from a vertical straight line. The eye appears usually forgiving of a wide horizontal line bending, such as a river or road, especially when it is perceived the angle of view is approaching 180 degrees. There is in fact some argument that across wider than 180 degrees the world is actually perceived in the brain with curved horizontal lines.

It will be appreciated that if the camera is held vertically aligned in portrait mode, the vertical lines may be redefined as horizontal lines, causing the entire grid system to rotate 90 degrees. Further, the camera may be aimed at other than the horizon, in which case the straightness of lines may be altered using the same projection. The examples given in this application usually refer only to a “landscape” oriented camera, however it may be appreciated without stating every conclusion twice, that the conclusions apply in an obviously altered way with a camera held in a “portrait” vertical orientation, and that such landscape-centric statements are not made to limit the scope of the patent to landscape only photography or indeed to exclude photography using a square aspect.

It is possible to design a projection with zero sphere distortion and zero vertical line distortion. Such a combination does uniquely define a projection. It is theoretically possible to build a lens with a projecting at a specific intermediate point between a rectilinear and a fisheye, and attach such a lens to the “circuit” camera described earlier to produce such a projection. The inventor knows of no such camera actually being built. However, as described earlier, even if such a camera were built, such a projection may not be perceived as perfect by the human visual system because of the conditioned optical illusion of expecting a positive sphere distortion with wide angle lenses. In addition, there is another distortion that is very important to the artistic control of images by photographers that can not be practically satisfied if sphere distortion and vertical line distortion are both driven to zero. This will now be defined as a third distortion.

Sphere distortion and vertical line distortion relate to the behavior of the mapping from the world in front of the lens onto the output image or flat print. The original image, for example the image initially captured by the camera with a fisheye lens mounted, is merely an intermediate stage in the production of the final image. In this view any lens that captured the scene could have been mounted on the camera, and although the mathematical formulae would change to accommodate this or that lens when projecting from the intermediate image, it would be possible to finish with an identical final image obeying the same distortions.

On the other hand, the “frame distortion” now defined relates to how the original image itself is mapped onto the output image, and in particular how the boundaries, or frame, of the output image is mapped. It is noted that if the hypothetical zero sphere distortion circuit camera disclosed above were built, it would give a projection that could not be derived from an intermediate image produced with common fisheye lenses without what will now be defined as frame distortion.

Referring again to FIG. 3, a camera 360 captures a scene 362, which it maps into an image 364. Image 364 has a boundary, which most likely is a rectangle. We will assume for now it is a horizontal rectangle, as this accounts for the vast majority of images actually made of today's world, the extrapolation to vertical will be obvious to one skilled in the art of photography. Whatever transformation we have chosen to minimize distortions maps the image 364 into an output image 370. Along with the image detail, such as mountains and people, the boundary 366 of the original captured image 364 also maps into the output space, where it typically is no longer a rectangle. If the mounted lens was a fisheye and the undistorting function was rectilinear, the rectangular frame 366 of the captured image would map to a strongly pin cushioned frame 372. Such a non-rectangular frame typically is not accommodated by image storage, viewing, or printing systems, and so it is cropped using either the largest interior rectangle 374, or the smaller largest interior rectangle with a predetermined aspect ratio 376. In either case, considerable detail in the intermediate image captured by the camera will be cropped out of the final image because it will be mapped beyond the interior rectangle.

This cropping is deleterious in several respects. From an artist's standpoint, a serious problem is that the image observed in the viewfinder of camera 360, which portrays the intermediate image 364, can not be used accurately to frame the subject. An artist discovers that the frame is the most important compositional element when crafting an image. A good artist will often align subjects close to or along with the frame. When a projection crops in from the frame, especially in a nonlinear curve, the ability to tightly compose, and the ability to “feel” the final composition as it will be delivered to a client, is lost. This loss of aesthetic framing control is a serious issue felt by artists, but often misunderstood by mathematicians designing a transformation. It is thus believed by the inventor that teaching and controlling this distortion is important to the advance of the art of fisheye lens transformations.

Framing distortion is defined as the percentage of image lost beyond the top and bottom rail, or edge, of the final cropped image bounded by the largest interior rectangle. In the case portrayed by mapping 380, framing distortion is zero because the top and bottom rails of the final image rectangle 382 map exactly to pixels or points along the top and bottom rails of the intermediate image mapped into output space 380. This definition does not account for mapping deviations from the narrower left and right edges, (typically top and bottom in a vertically aligned image) which are found to be less important compositionally. This lowered importance may be because they are shorter, further from the center, and further it is found that the eye of an artist typically “corrects” for the curvature of the shorter and more important vertical lines when “feeling” a composition.

It is possible to extend the definition of framing distortion to accommodate left and right rails. However practically it is not possible to alter left and right rail distortion while maintaining the aesthetically more important zero vertical line distortion, therefore extending the definition is, for the purposes of designing an aesthetically pleasing mapping function, academic.

Framing distortion is deleterious to the art in other ways also. By cropping out pixels, there is less detail available in the final image, therefore the image appears less clear in the same way a camera with fewer pixels tends to produce an image with lower clarity, all else being equal. In addition, the lost pixels caused by framing distortion are at the edge of the image. Removing them effectively reduces the angular coverage of the lens. A photographer normally chooses a fisheye in order to cover a very wide angle, and a projection that effectively reduces this angle is counter to the artistic intent of the photographer. As an example, a prior art rectilinear mapping from an image made with a full field fisheye lens is inclusive of only about 4 megapixels of a 6 megapixel intermediate image, which, along with extreme shrinking, or subsampling of the center of the image that further discarding detail from the included 4 megapixels, is why such mappings, although commonly available in the industry, typically produce unclear and grainy images, and appear to be rarely used commercially.

It has been discovered that mapping a fisheye intermediate image constrained to zero framing distortion and zero vertical line distortion does not allow concurrently zero sphere distortion, however it does produce a slight positive sphere distortion in the diagonal corners, typically 15% to 20% for a typical full field fisheye lens. Further it has been discovered that this positive sphere distortion can be uniformly distributed around the edge of the image by purposefully introducing a positive sphere distortion at the top and bottom, left and right of about 8% to 15% so the resulting elliptical spheroids are oriented as would be expected, and of magnitude as would be expected, from a moderate wide angle lens, and further it was discovered that this slight positive sphere distortion is of the magnitude needed to offset the optical illusion of negative sphere distortion seen by a human observer viewing what is perceived as a wide angle lens.

Expounded in more detail, with zero framing distortion and zero vertical line distortion, although the sphere distortion can still be controlled along a vertical line passing through the center of the image, and along a horizontal line passing through the center of the image, it can not be controlled along diagonal lines passing through the center of the image and the corners of the image. However the resulting sphere distortion along diagonal lines passing through the image corners is the correct amount to counteract the optical illusion, and so the sphere distortion along horizontal and vertical lines, which can be controlled, is made slightly positive to approximately match everywhere along the periphery of the image with the desired slight positive sphere distortion.

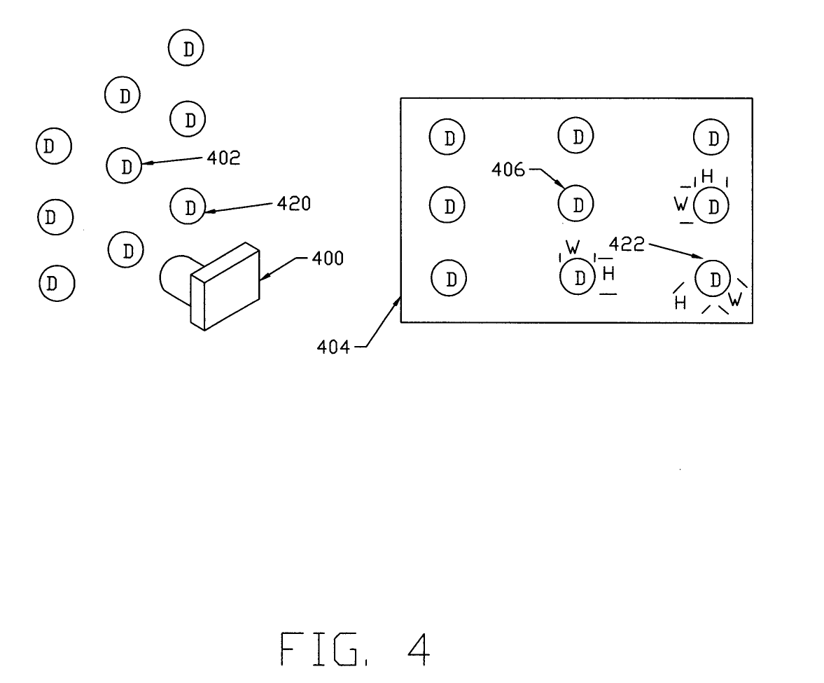

This is illustrated in FIG. 4 in which a camera fitted with a fisheye lens is surrounded by spheres, such as sphere 402. The image captured by the camera is unwrapped as taught by this invention to produce image 404 which contains an image 406 of sphere 402. A sphere 422 reproduces in image 404 as an elongated spheroid 422 with a height H and a width W oriented with the radial line. In a specific example of a commercial full field fisheye lens which together covers 180 degrees corner to corner diagonally across the image, the ratio of H to V is ideally about 1.15 to 1.20, although wider variations are accepted easily by the human eye between about 1.0 and 1.4, corresponding to a sphere distortion of 0% (no distortion) to +40% distortion, as defined. In a normal rectilinear lens, the amount of distortion is approximately proportional to the radial distance from the optical center of the image, and so the image of a sphere at the left and right edge should normally be adjusted to less sphere distortion than one at the corner, and the image of a sphere at the top or bottom edge of a portrait oriented horizontal image should be adjusted to less sphere distortion than one at the left or right edge.

In summary, it has been found that for fisheye lenses it is possible to warp from the intermediate captured image so as to produce an output image having substantially zero vertical line distortion as defined in this application, substantially zero framing distortion as defined in this application, and either zero, or a visually correct positive sphere distortion as defined in this application in the range between 0% and 40%, and ideally about 20% in the diagonal corners.

The optimum amount of positive sphere distortion is a function of the perceived angle of the lens, as it is to counteract an optical illusion that is based on perceived angle, and so the desired amount will be higher for a full circle fisheye and will be less for a longer focal length fisheye. Because the positive distortion counters an adaptation to images in society, the ideal value is expected to vary between individuals, and even between societies, and therefore the definition of ideal is left broad.

This combination of distortion constraints is novel and provides a useful projection that the inventor has discovered gives a very substantial improvement over all prior art projections when tested over a wide range of wedding, portrait, and event images. This projection is anticipated to provide a substantial advance to the art of fisheye images in particular, and ultrawide photography in general.

FIG. 7 illustrates a specific example. An intermediate image 702 is processed using computer program 109. The output image using a mapping following the teachings of this invention is displayed as image 704. For comparison an output image using a prior art rectilinear mapping is displayed as image 706. The images may be compared for distortions of specific elements. Vertical line distortion is illustrated by the chimney 710 and groom-to-be 712. Both were straight in real life, as they are in both images 704 and 706, but not in the fisheye intermediate image 702. Sphere distortion is illustrated in the faces of the groom-to-be 712 and bride-to-be 720. Practicing the methods of this invention, both faces are seen to be undistorted in image 704, but are negatively distorted in intermediate fisheye image 702 and are grossly positively distorted in rectilinear image 706. Framing distortion is illustrated by the inclusion of details along the top and bottom edges of intermediate fisheye image 702, including the top halves of windows 714 and 716. These windows are fully represented in output image 704 displaying zero framing distortion, but window 716 at the edge of the image is cropped in the rectilinear image 706 which displays framing distortion. The top edge of image 706 can be raised no farther to include window 716 because window 714 is fully represented. Along the bottom of the image, the rectilinear projection is seen to have cut off the legs of the groom-to-be 712 and most of the body of the bride-to-be 720.

A distortion produced by image mapping is like a cartography projection of a section of the globe onto a flat surface; once the mapping is mathematically defined, there are many means to substantially attain that mapping. The best mode will be taught primarily with polynomials, as this is believed to provide a mix of the fastest and simplest coding. It should be understood that other warping methods are possible, including a lookup table that copies by rote the warping expounded in the taught formulae, and that such warping methods effectively practice the invention as taught if they produce substantially the same effect.

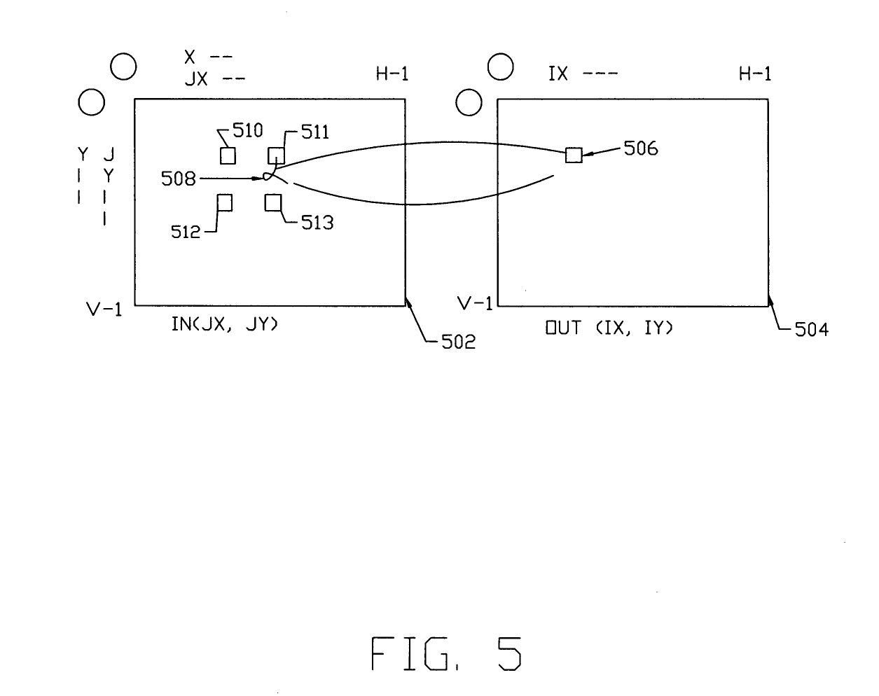

A specific realization will now be presented using computer pseudo code understandable by those skilled in the art of computer programming. Referring to FIG. 5, an intermediate fisheye image 502 is to be mapped to an output image 504. For the purposes of this illustration both images are assumed to be the same size of “H” horizontal pixels by “V” vertical pixels, and in the specific example this is further assumed to 2000×3008. The algorithm proceeds by scanning through each pixel in the output image, such as pixel 506. The algorithm will translate the position of that pixel from an integer IX,IY tuple into a floating point X,Y tuple pointing to a point 508 in the intermediate image 502. This point may not coincide precisely with a discrete pixel in the intermediate image, but typically lies between four bounding pixels 510 to 513. The brightness value that would have been at the precise X,Y location is calculated by interpolating the brightness between these four pixels. This interpolated value is then inserted into pixel 506 of the output image 504. It will be recognized that the example pseudo code uses linear interpolation. It will be understood by those in the art that many other forms of interpolation are available, such as bicubic interpolation that would use 5×5 pixels around point 508, and “sinc” that would use many more pixels, however a discussion of relative merits between interpolation methods is not relevant to this patent.

User defined variables:

H=3008

V=2000

RR=0.99

T=0.0

VS=1.1891

HS=1.1891

VC3=0.145

V3=0.1467

V5=0.07

VCQ3=0.18

HC=0.0

HC3=0.0

H3=0.36

H5=0.03

Precalculated variables:

R=((SQRT(H*H+V*V))/2.0)*RR

Loop iteration

For each IY from 0 to V−1 step 1 pixel

For each IX from 0 to H−1 step 1 pixel

X=IX

Y=IY

X=(X−(H−1)/2.0)/R

Y=−(Y−(V−1)/2.0)/R

X=X*HS

Y=Y*VS

VR=R/((VI−1.0)/2.0)

Y=Y−Y3*H3

Y=Y−Y*X2*HC

Y=Y+((Y*VR)5−(Y*VR)3)*H5

Y=Y+((Y*VR)3−(Y*VR))*X2*HC3

X=X−X3*V3

X=X+(X5−X3)*V5

X=X+(X3−X)*(Y2*VC3+Y4*VCQ3)

X=X−Y*T*(1.0−X2)

Y=Y+X*T*(1.0−(Y*VR)2)

TMP=1−Y2

If TMP>0 then X=X*SQRT(TMP); else X=0.0

X=X*R+(H−1.0)/2.0

Y=(−Y)*R+(V−1.0)/2.0

Interpolate point selected from IN image and place in OUT image

Limit X so that 0<=X<H−1

Limit Y so that 0<=Y<V−1

JX=Truncate(X)

JY=Truncate(Y)

FX=X−JX

FY=Y−JY

OUT(IX,IY)=
(1.0−FX)*(1.0−FY)*IN(JX,JY)
+FX*(1−FY)*IN(JX+1,JY)
+(1.0−FX)*FY*IN(JX,JY+1)
+FX*FY*IN(JX+1,JY+1)

End of IX and IY loops

Several of the variables are predefined to be zero in this example. Framing distortion will be zero if variable “HC” is zero. By specifying a non zero value for HC, an artist can purposefully reintroduce a controlled amount of horizontal line straightening at the expense of framing distortion.

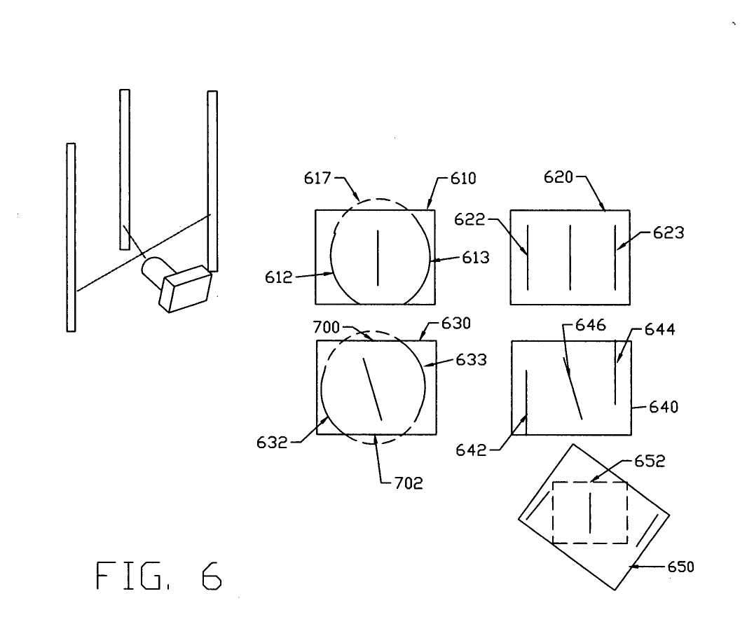

The “twist” variable “T”, set to zero by default in the example, has a very interesting property, as illustrated in FIG. 6. Imagine photographing with a full circle fisheye lens that can capture 180 degrees across the horizon. Now imagine imaging three straight vertical poles, one 90 degrees to the left 602, one straight ahead 604, and one 90 degrees to the right 606. In the intermediate image 610, the images 612 and 613 of the left and right poles will be coincident along the perfect circle 616 that defines the edge of the 180 degree lens. When unwarped in the output image 620, the images 622 and 623 of these poles will be vertical and straight at the left and right edges of the image. Now imagine the camera was slightly rotated along the optical axis by 10 degrees clockwise to produce intermediate image 630. Perhaps the photographer was a bit tired or distracted, as often happens, and failed to hold the camera perfectly level. Note however that the images 632 and 633 of the left and right poles still appear precisely along the image edge in the output image 640, and so are unwarped to be still perfectly vertical, although the image 642 of the left pole has moved down and the image 644 of the right pole has moved up. The center pole 646 now however lists by 10 degrees counterclockwise. If the photographer later tries to straighten this image 640 by conventional rotate and crop as illustrated in image 650, not only will the edge poles be tilted in error, but will be cropped out as shown by the new bounding box 652.

The “T” variable allows the photographer to realign the center pole to vertical while retaining the already vertical alignment of the side poles, while repositioning the side poles horizontally, and without cropping off any pixels. The effect is very similar to the ideal level image previously shown as 620. Furthermore the “T” variable provides some compromises to mathematically perfect perspective control in order to maintain zero framing distortion to preserve pixels data along the top and bottom rails 700 and 702. For small camera tilts these compromises are found to be almost always unnoticeable because of the wide angles already being captured. For small camera tilts, it is thus possible with a fisheye using the “T” variable to recover the level of a misaligned image without losing any pixels. For a full field fisheye the effect is not as mathematically perfect, but still is found to work very well in practice. The effect of the “T” variable is very important to the rotate and crop function with fisheye lenses, where the rules differ from conventional images, and conventional rotate and crop does not work well.

The variable “RR” is roughly the radius of the circle in the image into which the 180 degree “great circle” around the lens is mapped. It is relative to the distance between the center of the image and an extreme corner, so in the ideal case of a 180 degree full field fisheye it would be exactly 1.0, and for a full circle fisheye it would be about 0.5, depending somewhat on how the circle fit into the aspect ratio of a particular sensor.

Variable “V3” controls the amount of sphere distortion. When it is set correctly, faces appear undistorted across the left to right expanse of the image. Because this variable attempts to overcome a preconditioned illusion of the human visual system, it must be adjusted visually rather than by measurement. As V3 grows beyond the optimum point for face distortion, the images take on more of a rectilinear aesthetic but without framing distortion. By distorting the edges through expansion, some images take on an expansive, Renaissance aesthetic, however as the edges are expanded and the center compressed, the information in the image is presented less effectively, and the image as a whole appears less clear. It is sometimes useful to adjust V3 manually to attain a desired aesthetic.

Variables “VS” and “HS” are basic magnifications that should be adjusted so the intermediate image just fills the output image. The horizontal magnification is affected by V3, so there may be times for aesthetic purposes to have unmatched horizontal and vertical magnifications, else VS and HS normally should be the same to keep a midline circle a circle.

It is desirable in some applications, after variables have been manually entered, to recalculate V3 so the input image is automatically made to fit the aspect of the output image precisely, then recalculate VS and HS so the input image automatically precisely fits the output image.

The effect of other variables is better seen empirically. Explaining this or that distortion is not further illustrative of the invention, and for one attempting to practice the invention, it is faster and better just to see the result by varying a parameter. In certain embodiments of the invention, the user may want direct control of the previously described parameters or some combinations of these parameters. One method to accomplish this is to provide a control method for the parameters. The use of sliders in a graphical user interface would allow control of one, several, or all of the parameters described in the unwarping specification above. The use of such a slider (or set of sliders) could allow user control of unwarping across images captured from various camera lenses and sensors.

It will be understood by those skilled in the art that variations are possible without departing from the scope and spirit of the invention. For example, a color image may obviously be unwarped by applying the invention to each color plane separately, perhaps with very slightly different parameters to account for lens aberrations. Although human subjects are repeatedly mentioned in the teaching as important, this is not intended in any way to suggest the invention is exclusionary of animals or indeed any other subject. Although an example is given using computer pseudo code, it is understood by those in the art that any coded algorithm may also be implemented in digital hardware or in a combination of hardware and software, or may be imbedded in a product such as a cellphone or camera. Accordingly nothing in the teaching should be considered to intend to limit the scope to a specific example.

Throughout the description and claims of this specification the word “comprise” and “includes,” as well as variations of that word, are not intended to exclude other additives, components, integers or steps. While the preferred embodiments of the invention has been particularly shown and described in the foregoing detailed description, it will be understood by those skilled in the art that various other changes in form and detail may be made without departing from the spirit and scope of the invention as set forth in the appended claims.

What is claimed is:

1. A non-rectilinear lens correction program operable to:
receive an original image created using a non-rectilinear lens;
mapping the original image to a flat surface;
processing the mapped image to reduce:
vertical line distortion;
spherical distortion; and
frame distortion;
outputting the processed image as a corrected image.

2. The non-rectilinear lens correction program of claim 1, wherein processing the mapped image operates to minimize spherical distortion.

3. The non-rectilinear lens correction program of claim 1, wherein processing the mapped image operates to reduce spherical distortion within the range of 70 percent to 95 percent.

4. The non-rectilinear lens correction program of claim 1, wherein processing the mapped image operates to minimize vertical line distortion.

5. The non-rectilinear lens correction program of claim 1, wherein processing the mapped image operates to reduce vertical line distortion by at least 95 percent.

6. The non-rectilinear lens correction program of claim 1, wherein processing the mapped image operates to minimize frame distortion.

7. The non-rectilinear lens correction program of claim 1, wherein processing the mapped image operates to minimize horizontal frame distortion.

8. The non-rectilinear lens correction program of claim 1, wherein processing the mapped image also includes minimizing the horizontal line distortion.

9. The non-rectilinear lens correction program of claim 1, wherein processing the mapped image individually minimizes the spherical, frame and vertical line distortion.

10. The non-rectilinear lens correction program of claim 1, wherein the original image is mapped using polynomials.

11. The non-rectilinear lens correction program of claim 1, wherein the non-rectilinear lens correction program also includes manual controls that allow a user to adjust the distortion.

12. The non-rectilinear lens correction program of claim 1, wherein outputting the processed image includes printing the processed image.

13. The non-rectilinear lens correction program of claim 1, wherein the original image created using a non-rectilinear lens is created using a fisheye lens.

14. A method for non-rectilinear lens image planar projection comprising:
receiving an original image created using a non-rectilinear lens;
mapping the original image to a flat surface;
processing the mapped image to reduce:
vertical line distortion;
spherical distortion; and
frame distortion;
outputting the processed image.

15. The method of claim 14, wherein processing the mapped image operates to minimize spherical distortion.

16. The method of claim 14, wherein processing the mapped image operates to minimize vertical line distortion.

17. The method of claim 14, wherein processing the mapped image operates to minimize frame distortion.

18. The method of claim 14, wherein processing the mapped image operates to individually minimize spherical, vertical line and frame distortion.

19. The method of claim 14, wherein processing the mapped image further allows a user to manually adjust the distortion.

20. The method of claim 14, wherein outputting the processed image includes printing the processed image.
